(19) United States
(12) Patent Application Publication
(10) Pub. No.: US 2023/0036727 A1
(43) Pub. Date: Feb. 2, 2023

(54) BEAMFORMED WIRELESS COMMUNICATIONS

(71) Applicant: Telefonaktiebolaget LM Ericsson (publ), Stockholm (SE)

(72) Inventors: Anteneh Atumo GEBREMARIAM, MALMÖ (SE); Håkan SCHANG, FÖRSLÖV (SE); Raymundo RAMIREZ-GUTIERREZ, LUND (SE); Hong ZHU, LUND (SE)

(21) Appl. No.: 17/786,737

(22) PCT Filed: Dec. 17, 2019
(86) PCT No.: PCT/SE2019/051300

§ 371 Date: Jun. 17, 2022

(51) Int. Cl. H04B 7/06; H04W 36/32

(52) U.S. Cl. CPC H04B 7/0695; H04W 36/32

(57) ABSTRACT

A method of data transfer between a radio unit and a mobile wireless device includes obtaining a value for a measure of a location of the mobile wireless device relative to the radio unit. When the measure of the location indicates that the mobile wireless device is nearer to the radio unit than a speed-dependent threshold value, any required beam switch is made to one of a plurality of predefined wide beams for data transfer between the radio unit and the mobile wireless device. When the measure of the location indicates that the mobile wireless device is further from the radio unit than the speed-dependent threshold value, any required beam switch is made to one of a plurality of predefined narrow beams for data transfer between the radio unit and the mobile wireless device.

### TECHNICAL FIELD

This relates to wireless communications, and in particular to data transfer between a radio unit and a mobile wireless device using beamforming.

### BACKGROUND

In the field of wireless communications systems, the 3rd generation partnership project (3GPP) is working to standardize the 5th generation (5G) radio access technology, which is referred to as New Radio (NR). In order to allow high data rates and bandwidth increases, it is proposed to use millimeter wave (mmW) communication, at frequencies in the region of, say, 20-50 GHz or higher, and wavelengths of the order of 15 mm or lower, as this provides a large block of available spectrum.

One issue is that electromagnetic waves at these higher wavelengths suffer from higher attenuation than lower frequency waves, when transmitted through air. In order to overcome or mitigate the effects of the path loss, one technique is to use several antenna elements in an array to perform beamforming for directional signal transmission and reception.

In one system, a number of wide beams are defined, covering a cell of the cellular communication network such that a desired output power is achieved over the whole cell. These wide beams are used by a radio unit in the cell for transmitting a synchronization signal. When a user wishes to communicate with the cell, it performs a random access procedure. Once the access has been performed, the user is allocated to a narrow beam, because narrow beams provide a greater signal strength as compared to wide beams, and this translates to a higher user performance.

This system works satisfactorily for stationary users, or users moving at low speeds. However, it has now been recognised that, for users moving at high speeds, who are located close to the radio unit, there is a potential problem in that such users may not remain within a serving narrow beam for a long enough time to perform a beam tracking and switching procedure, and switch to a new serving narrow beam.

Therefore, there is a danger that such a user may lose connection to the radio unit, in which case the user will need to initiate another random access procedure.

### SUMMARY

According to an aspect of the present invention, there is provided a method of data transfer between a radio unit and a mobile wireless device. The method comprises obtaining a value for a measure of a location of the mobile wireless device relative to the radio unit. When the measure of the location indicates that the mobile wireless device is nearer to the radio unit than a speed-dependent threshold value, data transfer between the radio unit and the mobile wireless device is switched to one of a plurality of predefined wide beams. When the measure of the location indicates that the mobile wireless device is further from the radio unit than the speed-dependent threshold value, data transfer between the radio unit and the mobile wireless device is switched to one of a plurality of predefined narrow beams.

The method may comprise determining a value of a parameter that is dependent on the distance between the radio unit and the mobile wireless device; comparing the determined value of the parameter with the speed-dependent threshold value; and determining whether the mobile wireless device is relatively near to the radio unit, or relatively far from the radio unit, depending on whether the determined value of the parameter is greater than or less than the threshold value.

The parameter that is dependent on the distance between the radio unit and the mobile wireless device may comprise a parameter relating to a signal strength of signals received by the radio unit from the mobile wireless device. In that case, the method may comprise determining that the mobile wireless device is relatively near to the radio unit if the determined value of the parameter relating to the signal strength is greater than the speed-dependent threshold value, and determining that the mobile wireless device is relatively far from the radio unit if the determined value of the parameter relating to the signal strength is less than the speed-dependent threshold value.

The parameter that is dependent on the distance between the radio unit and the mobile wireless device may comprise a parameter relating to a time taken for signals transmitted by the mobile wireless device to be received by the radio unit. In that case, the method may comprise determining that the mobile wireless device is relatively near to the radio unit if the determined value of the parameter relating to the time taken is less than the speed-dependent threshold value, and determining that the mobile wireless device is relatively far from the radio unit if the determined value of the parameter relating to the time taken is greater than the speed-dependent threshold value.

The method may comprise determining a position of the mobile wireless device using a positioning system, and the parameter that is dependent on the distance between the radio unit and the mobile wireless device may then comprise a measure of said distance. In that case, the method may comprise determining that the mobile wireless device is relatively near to the radio unit if the measure of said distance is less than the speed-dependent threshold value, and determining that the mobile wireless device is relatively far from the radio unit if the measure of said distance is greater than the threshold value.

The method may comprise setting the speed-dependent threshold value based on a measured or calculated speed of the mobile wireless device.

The method may comprise setting the speed-dependent threshold value based on an assumed speed of the mobile wireless device, dependent on a location of the radio unit.

The method may comprise identifying a best available wide beam and a best available narrow beam. The method may then further comprise, based on the measure of the location and the speed-dependent threshold value, determining whether any switch should be to the best available wide beam or the best available narrow beam. The method then comprises, if it is determined that a beam switch is necessary, switching to the best available wide beam or the best available narrow beam for data transfer between the radio unit and the mobile wireless device.

The method may comprise identifying the best available wide beam and the best available narrow beam based on measurement reports from the mobile wireless device.

The method may further comprise determining whether a beam switch is necessary based on measurement reports from the mobile wireless device.

According to another aspect, there is provided a system for data transfer between a radio unit and a mobile wireless device. The system is configured for performing the method according to the first aspect.

According to another aspect, there is provided a network node comprising a processor and a memory. The memory contains instructions for causing the processor to perform the method according to the first aspect.

According to another aspect, there is provided a computer program product, comprising machine-readable instructions for causing a suitable programmed processor to perform the method according to the first aspect.

The instructions may be stored on a tangible and/or non-transitory medium . . . .

This has the advantage that data transfer may be carried out via either narrow beams or wide beams, depending on the UE's (measured or assumed) speed and its location with respect to the radio unit, in order to provide improved beam tracking. This may result in reduced radio link failures due to beam losses, and reduced random access failures.

### BRIEF DESCRIPTION OF THE DRAWINGS

For a better understanding of the present invention, and to show how it may be put into effect, reference will now be made, by way of example only, to the accompanying drawings, in which:—

FIG. 1 shows data transfer between a radio unit and a mobile wireless device using beamforming;

FIG. 2 illustrates wide beams used in the data transfer illustrated in FIG. 1;

FIG. 3 illustrates narrow beams used in the data transfer illustrated in FIG. 1;

FIG. 4 illustrates a network node according to an aspect of the invention;

FIG. 5 illustrates a part of a communications module in the network node of FIG. 4, in one embodiment;

FIG. 6 illustrates a part of a communications module in the network node of FIG. 4, in another embodiment;

FIG. 7 illustrates a process of beam selection;

FIG. 8 illustrates a mobile wireless device moving in a coverage area of a network node;

FIG. 9 illustrates in more detail the mobile wireless device moving in the coverage area of the network node;

FIG. 10 is a first flow chart illustrating a method in accordance with an aspect of the invention;

FIG. 11 is a second flow chart illustrating a method in accordance with an aspect of the invention; and

FIG. 12 is a third flow chart illustrating a method in accordance with an aspect of the invention.

### DETAILED DESCRIPTION

Embodiments will now be described with reference to the accompanying drawings. It will be appreciated that these embodiments are provided by way of example only, and that variations and modifications may be made within the scope of the invention as defined by the claims.

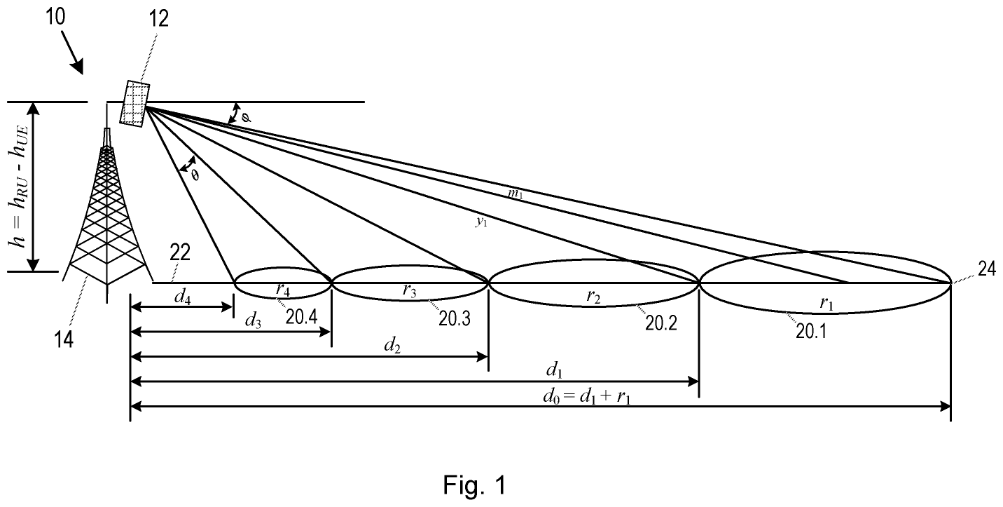

FIG. 1 illustrates the operation of data transfer between a radio unit and a mobile wireless device using beamforming.

Specifically, FIG. 1 shows a network node 10, which in this example takes the form of a New Radio (NR) radio access node (also referred to as a gNB), which comprises a radio unit that includes transceiver circuitry and a directional antenna unit 12. The antenna unit 12 is mounted on a tower 14 so that it is elevated above the ground. Specifically, the antenna unit 12 is located at a height h_{RU} relative to some normalised elevation, with the assumed height of each User Equipment device (UE) relative to the same normalised elevation being designated as h_{UE}, which may correspond to the local ground level. Thus, the height of the antenna unit 12 above that assumed UE height is given by h=h_{RU}−h_{UE}. As described in more detail below, the height of the antenna unit 12 above the assumed UE height determines the sizes of the beams, as seen by the UEs.

The directional antenna unit generates multiple beams, each having a certain angular extent in the elevation direction and having a certain angular extent in the azimuthal direction.

FIG. 1 shows four different beams 20.1, 20.2, 20.3, 20.4, the centres of which are located along a line 22 extending from below the directional antenna unit 12.

The directional antenna unit 12 has a downward tilt of φ, meaning that the furthest point 24 of the beam 20.1 from the antenna unit 12 is at an angle of φ below the horizontal from the antenna unit 12. Simple geometry therefore shows that the point 24 is at a horizontal distance d₀=(h/tan φ) from the antenna unit 12.

Each of the beams 20.1, 20.2, 20.3, 20.4 has an angular extent of θ in the elevation direction. Thus, the beam 20.1 extends for a distance r₁ along the line 22, the beam 20.2 extends for a distance r₂ along the line 22, the beam 20.3 extends for a distance r₃ along the line 22, and the beam 20.4 extends for a distance r₄ along the line 22. The distances r₁, r₂, r₃, and r₄ can all be calculated from knowledge of h, φ, and θ.

Based on the cell coverage area, wide and narrow beams can be predefined, such that they cover the whole of a target area, for example a cell served by a specific radio unit, with the desired output power.

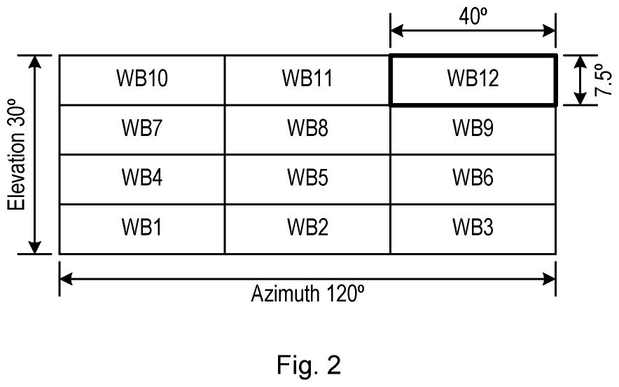

FIG. 2 illustrates wide beams used in the millimetre wave data transfer illustrated in FIG. 1, in one example. In this example, the cell has a coverage area of 120° in azimuth and 30° in elevation. Although FIG. 2 shows a relatively regular arrangement of beams, the methods described herein are applicable to any shape of coverage area.

In this example, the coverage area is divided into 12 wide beams (WBs), i.e. WB1, WB2, WB3, . . . , WB12, each covering 7.5° in elevation and 30° in azimuth.

These wide beams may be used for transmitting a synchronization signal block (SSB) and for beam refinement in an initial random access (RA) procedure.

Once the initial access has been performed, the radio access node (i.e. the gNB) uses narrow beams, also known as traffic beams, to transmit data to and/or receive data from the users.

Narrow beams have narrower azimuth and/or elevation angles as compared to wide beams.

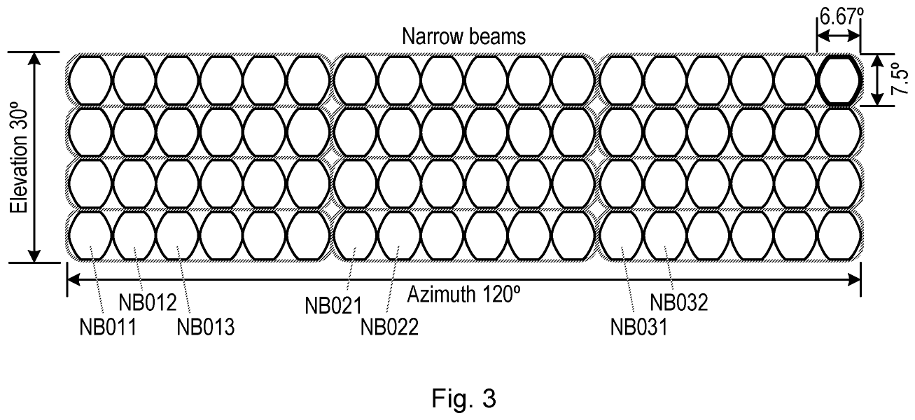

FIG. 3 illustrates an example of narrow beams used in the data transfer illustrated in FIG. 1. In this illustrated example, the narrow beams have narrower azimuth angles than the wide beams shown in FIG. 2, but have the same elevation angles. In this example, each wide beam consists of 6 narrow beams. Thus, the wide beam WB1 consists of the narrow beams NB011, NB012, NB013, . . . ; the wide beam WB2 consists of the narrow beams NB021, NB022, . . . ; and the wide beam WB3 consists of the narrow beams NB031, NB032, . . . . Thus, each narrow beam covers 7.5° in elevation and 6.67° in azimuth.

It will be noted that these figures are provided by way of illustration only, and that the methods described herein can be used with any shape of coverage area, and with any predefined combination of wide beams and narrow beams.

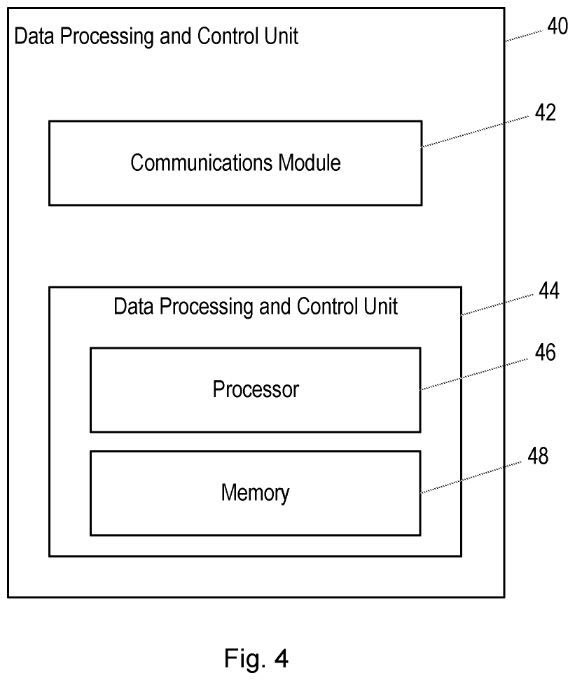

FIG. 4 illustrates the general form of a network node according to an aspect of the invention.

Specifically, FIG. 4 illustrates a network node 40 that includes a communications module 42 and a data processing and control unit 44. The data processing and control unit 44 includes a processor 46 and a memory 48. The processor 46 performs data processing and logical operations, and the memory 48 stores working data and program instructions for causing the processor to perform the methods described herein. The program instructions for causing the processor to perform any of the methods described herein may be provided in any computer-readable form, including on a tangible and/or non-transitory medium. The communications module 42 generates signals in a suitable form for transmission in accordance with a suitable communications standard, and includes radio transceiver circuitry. The communications module also includes the directional antenna unit 12 shown in FIG. 1.

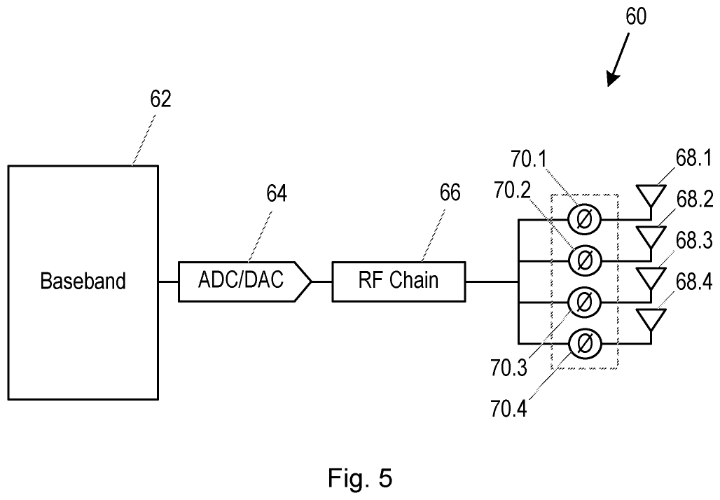

FIG. 5 illustrates a part of the communications module 42 in the network node of FIG. 4, in one embodiment.

Specifically, FIG. 5 shows analog beamforming circuitry 60 for use in the communications module 42.

The baseband signal processing circuitry 62 is connected in the receive path to analog-digital convertors (ADC) and in the transmit path to digital-analog convertors (DAC) 64, and then to a radio frequency (RF) signal processing chain 66, and then to a plurality of antenna elements 68.1, 68.2, 68.3, 68.4 through respective gain and phase adjustment elements 70.1, 70.2, 70.3, 70.4.

Thus, the circuitry 60 uses analog beamforming. In the case of signals for transmission, the baseband radio signal is split using a power divider before the analog beamformer. The beamforming weights are applied by the respective gain and phase adjustment elements 70.1, 70.2, 70.3, 70.4 in the path towards each antenna element 68.1, 68.2, 68.3, 68.4. The amplitude and phase variations are applied by the gain and phase adjustment elements 70.1, 70.2, 70.3, 70.4 to the analog signal (that is, after the digital-analog conversion) at the transmit end. In the case of received signals, the signals from the different antenna elements 68.1, 68.2, 68.3, 68.4 are summed before the analog-digital converter.

Based on the choices of the beamforming weights for each antenna element, several beams can be generated and could be directed in different directions to serve different users. In addition, depending on the choices of the weights, it is possible to control the output power and the width of each beam both in the azimuth and elevation directions.

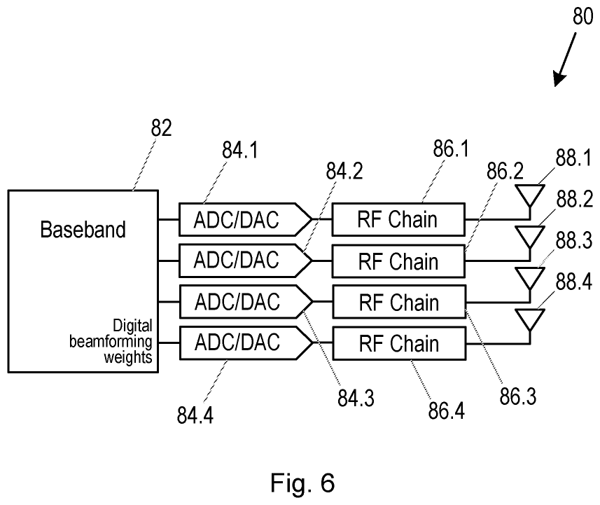

FIG. 6 illustrates a part of a communications module in the network node of FIG. 4, in another embodiment.

Specifically, FIG. 6 shows digital beamforming circuitry 80 for use in the communications module 42.

In the case of digital beamforming a separate RF chain is used per antenna element. In addition, the beamforming weights are applied in the digital domain in the baseband. This enables the transmission of multiple data streams towards different users over different beams at the same time. By contrast, in analog beamforming we have a single data stream transmitted at a time towards a single user.

Thus, in FIG. 6, in the case of signals for transmission, the baseband signal processing circuitry 82 applies the beamforming weights to the multiple data streams, which are applied to respective digital-analog convertors 84.1, 84.2, 84.3, 84.4, and then to respective radio frequency (RF) signal processing chains 86.1, 86.2, 86.3, 86.4, and then to a plurality of antenna elements 88.1, 88.2, 88.3, 88.4.

Although digital beamforming allows multiple beams to be generated for transmission, using digital beamforming over the whole of the available bandwidth, of hundreds of MHz, would need a large number of DAC and ADC components. This would result in an increased cost and high power consumption. To mitigate these issues, analog beamforming is widely used, despite its inherent drawbacks. Since in analog beamforming a single beam is generated at a time directed to a single user in a particular transmission time interval (TTI), it is necessary to effectively track the user's movement in order to achieve the required performance.

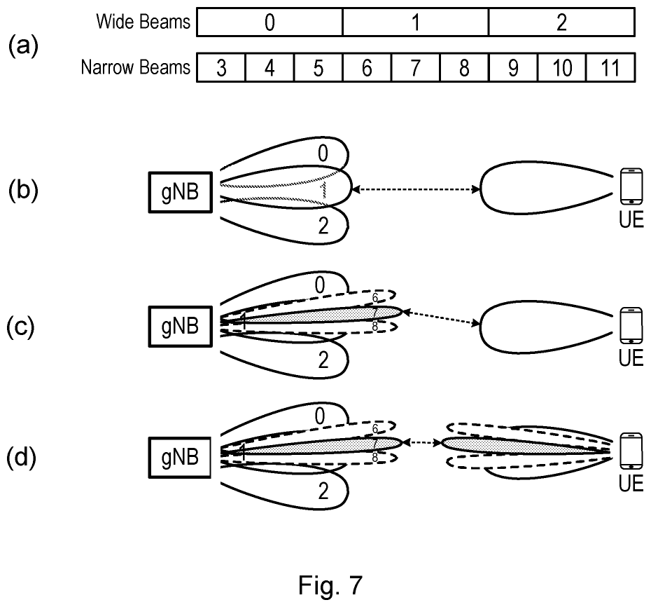

As discussed in more detail below, this issue is challenging when users are moving with high speed. The disclosure herein therefore describes an improvement to the existing beam tracking algorithm to effectively track users moving with high speed. FIG. 7 illustrates a process of beam selection.

The beam management is defined as a set of procedures performed in protocol layer 1 (L1) and layer 2 (L2) in order to maintain a set of transmit/receive pairs and/or UE beams that can be used for downlink (DL) and uplink (UL) transmission/reception via beam determination, beam measurement, beam reporting and beam sweeping.

These procedures are referred to as P1, P2 and P3 L1/L2 beam management procedures.

FIG. 7(a) shows an example, in which the gNB has a set of three predefined wide beams (referred to as beams 0, 1 and 2). Wide beam 0 is divided into three predefined narrow beams (referred to as beams 3, 4 and 5); wide beam 1 is divided into three predefined narrow beams (referred to as beams 6, 7 and 8); and wide beam 2 is divided into three predefined narrow beams (referred to as beams 9, 10 and 11.

In the P1 procedure for beam establishment, shown in FIG. 7(b), the synchronization signal block (SSB) is transmitted in a beam sweep over the coverage area, using the wide beams 0, 1, and 2. This allows the UE to make measurements on the different SSB beams in order to be able to select the best SSB beam. The UE can select one of the SSBs with a Reference Signal Received Power value that is greater than a threshold value, which is defined in Radio Resource Control (RRC) i.e. RSRP>rsrp-ThresholdSSB. If there is no SSB with a Reference Signal Received Power value that is greater than the threshold value, the UE may select any SSB.

In FIG. 7(a), wide beam 1 is selected.

The UE may then perform an initial access via the Physical Random Access Channel (PRACH).

After the Random Access procedure is completed, the P2 procedure for gNB beam refinement and tracking, shown in FIG. 7(c), is triggered.

During the P2 procedure, the Aperiodic Channel State Information—Reference Signal (CSI-RS) is transmitted in a beam sweep over the narrow beams within the wide beam that was selected in the P1 procedure.

The UE monitors the received CSI, and sends reports to the gNB, which is then able to find the best narrow beam within the previously selected wide beam.

In FIG. 7(c), narrow beam 7 is selected. The procedure then involves the gNB switching from the wide beam 1 to the narrow beam 7 for the subsequent data transfer.

When the UE has selected a narrow beam, the P3 procedure for UE beam refinement and tracking, shown in FIG. 7(d), is performed during the subsequent data transfer. This assumes that the UE has the capability to beamform.

In the P3 procedure, the UE makes measurements on the selected gNB transmit beam, for example using the SSB and/or the Tracking Reference Signal (TRS) and/or the aperiodic Channel State Information-Reference Signal (CSI-RS). If the UE uses beamforming, it can change its UE receive beam if desired.

As discussed previously, this procedure works generally satisfactorily for UEs that are stationary or slow-moving, and for UEs that are relatively far from the radio unit. However, it is now recognised that this procedure may not work satisfactorily for UEs that are fast-moving and relatively close to the radio unit.

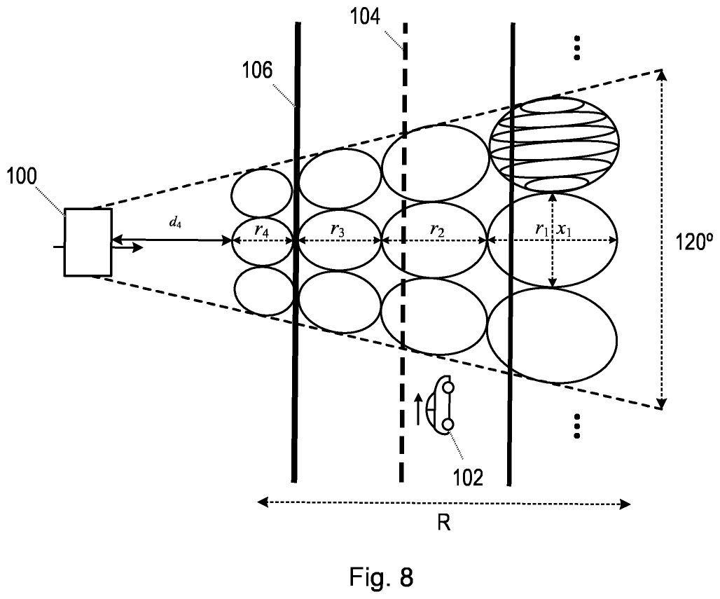

FIG. 8 is a schematic illustration of a mobile wireless device moving in a coverage area of a network node.

FIG. 8 is a plan view, based on the deployment shown in FIGS. 1, 2 and 3, in a situation in which the elevation coverage range of 30° is divided between four beams, each of 7.5°, and the azimuth coverage range of 120° is divided between three wide beams, each of 40°, with each of these wide beams being divided into six narrow beams, each of 6.67°. Thus, FIG. 8 shows the shape of these beams on the ground, with the elevation coverage range of 30° corresponding to a total distance R on the ground.

The dimensions of the beams in a first direction extending directly away from the radio unit 100 are the distances r₁, r₂, r₃, and r₄, as described with reference to FIG. 1. The edges of the beams that are nearest to the radio unit 100 are at respective distances d₁, d₂, d₃, and d₄ from the radio unit. The dimensions of the beams in a second direction transverse to the first direction can be defined as x₁, x₂, x₃, and x₄.

FIG. 8 shows a vehicle 102 containing a UE moving along the line 104 in the second direction, that is, in the azimuth direction. Thus, the radio unit 100 is facing a road 106 along which the vehicle 102 is travelling, which is a typical urban deployment scenario.

If we have a value v for the speed with which the UE is moving, we can calculate the time that the UE will spend in each narrow beam.

Using the parameters defined in connection with FIG. 1, namely an antenna height of h, a downward antenna tilt of φ, and a beam angular extent of θ in the elevation direction, as well a beam angular extent of Φ in the azimuth direction, and for a UE moving with a speed of v [km/h], at distance of dₖ+rₖ/2 from the radio unit inside any of the four beams in the elevation direction, xₖ is the distance covered by the UE inside a narrow beam.

The time taken by the UE to cross the narrow beam can then be calculated as follows:

$$t [ ms ] = \frac{{x}_{k} [ m ]}{\frac{v}{3.6} [ \frac{m}{s} ]} = \frac{2 tan ( \frac{∅}{2} ) \sqrt{{( {d}_{k} + \frac{{r}_{k}}{2} )}^{2} + {h}^{2}} [ m ]}{\frac{v}{3.6} [ m / s ]} * 1000 , \qquad ( 1 )$$

$$where {d}_{k} = \frac{h}{tan ( φ + k θ )} and {r}_{k} = \frac{h}{tan ( φ + ( k - 1 ) θ )} - \frac{h}{tan ( φ + k θ )} .$$

Thus, it can be seen that the time taken to cross the narrow beam depends on the UE speed, the vertical antenna tilt, narrow beam width in the azimuth direction and the antenna height.

In some planned implementations of the beam selection procedures described above, and in particular the P2 narrow beam selection procedure, the UE will make measurements with a periodicity of less than 100 ms, for example 80 ms or 40 ms. If the time taken for a UE to cross a narrow beam, as calculated using equation (1) above, is less than the periodicity of the UE measurements, it will be difficult for the UE to make the measurements required by the P2 procedure, and there is a significant risk that the UE will lose the beam, and will then need to initiate a random access procedure.

Simply by way of illustration, considering an example scenario of a UE moving at 60 km/h with Ø=6.67°, θ=7.5°, φ=3.5° and h=5 m, when the UE distance from the

$$RU ( {d}_{k} + \frac{{r}_{k}}{2} )$$

is less than 8 m, then the narrow beam crossing time is less than 40 ms. In this situation, the UE will not have enough time to obtain the beam tracking CSI reports required by the P2 procedure while it is attached to the same narrow beam.

In such conditions, the UE may need to start a Random Access procedure via SSBs. During this period, there will not be any data transmission to or from the UE, leading to a bad performance until the connection is resumed, and assuming the UE will then be at a distance from the radio unit that allows it to perform proper beam tracking.

The possibility of a beam failure because the UE crosses a narrow beam more quickly than the periodicity of the measurement opportunities increases when a UE is configured with Connected mode Discontinuous Reception (C-DRX), in which case a C-DRX cycle of 80 ms is configured, during which a UE is in sleep mode for more than 70 ms of the cycle. In this mode, successful beam tracking requires that the C-DRX enabled UE should stay in a single narrow beam for at least 80 ms.

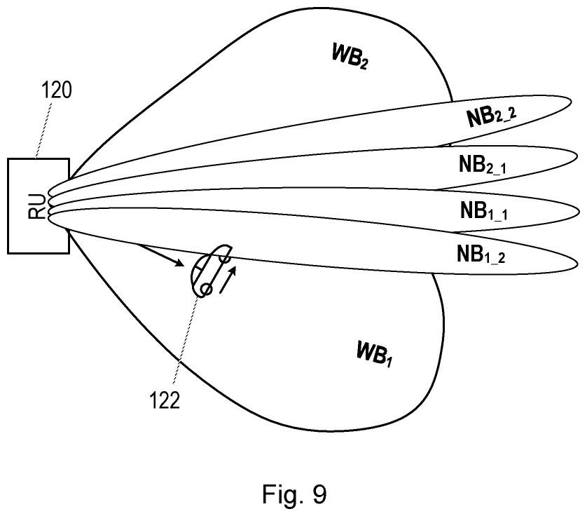

FIG. 9 illustrates in more detail the mobile wireless device moving in the coverage area of the network node.

Specifically, FIG. 9 shows a situation in which a radio unit 120 is operating with predefined wide beams WB1, WB2 at least. Wide beam WB1 includes narrow beams NB1_1 and NB1_2 at least, and wide beam WB2 includes narrow beams NB2_1 and NB2_2 at least.

A UE is located in a vehicle 122 that is at a distance

$${d}_{k} + \frac{{r}_{k}}{2}$$

from the radio unit.

When this distance is small, and when the UE is fast-moving, there is a danger that the UE will lose the beam, as discussed above.

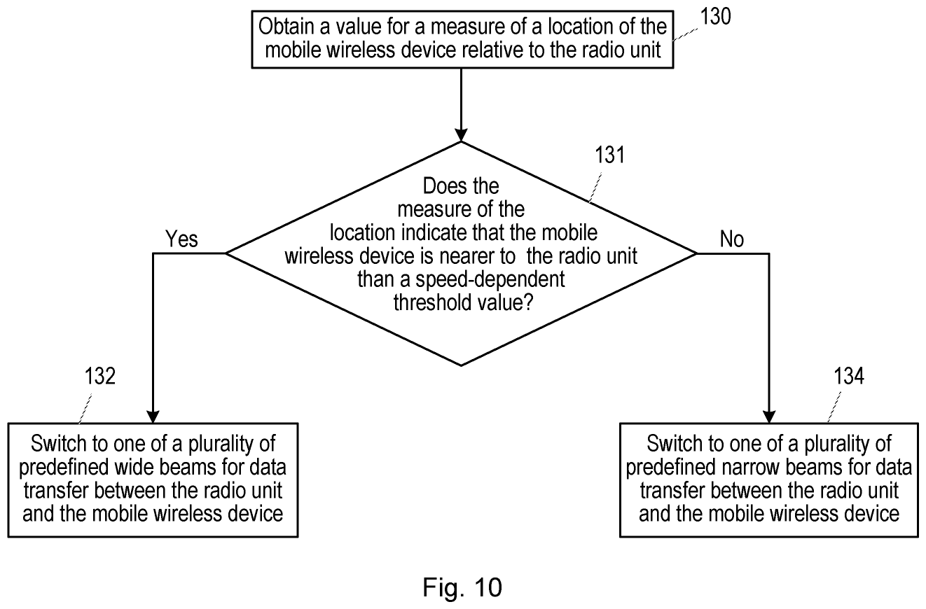

FIG. 10 is a first flow chart, illustrating a method of data transfer between a radio unit and a mobile wireless device. The method comprises, at step 130, obtaining a value for a measure of a location of the mobile wireless device relative to the radio unit. In step 131, it is then determined whether the measure of the location indicates that the mobile wireless device is nearer to the radio unit than a speed-dependent threshold value. When it is determined that the measure of the location indicates that the mobile wireless device is nearer to the radio unit than a speed-dependent threshold value, the method passes to step 132, involving switching to one of a plurality of predefined wide beams for data transfer between the radio unit and the mobile wireless device. Alternatively, when the measure of the distance indicates that the mobile wireless device is further from the radio unit than the speed-dependent threshold value, the method passes to step 134, involving switching to one of a plurality of predefined narrow beams for data transfer between the radio unit and the mobile wireless device.

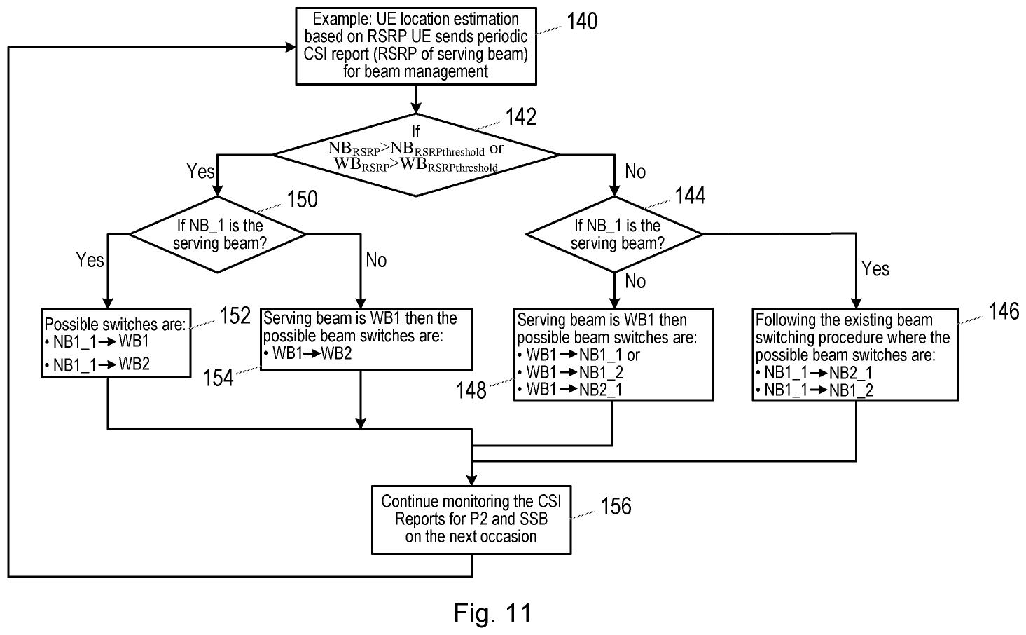

FIG. 11 is a second flow chart, illustrating in more detail an example of a method performed by a network node, for determining which beam should be used for data transfer between a radio unit and a mobile wireless device.

In general terms, it can be said that this method involves determining whether a mobile wireless device is so close to the radio unit, and so fast-moving, that it is in danger of losing a serving narrow beam. If it is, then it is determined that the mobile wireless device should not use a narrow beam for data transfer, but should instead use a wide beam for data transfer.

The method begins when the mobile wireless device, or UE, has a serving beam, which may be a narrow beam if the P2 refinement procedure has just been performed, or which may (as briefly mentioned above, and as described in more detail below) be either a narrow beam or a wide beam if the P2 tracking procedure is being performed.

At step 140, a value is obtained for a measure of a location of the mobile wireless device relative to the radio unit. As will be clear, the relevant location is the location relative to the antenna unit that is used for transmission and reception of signals.

In the specific embodiment shown in FIG. 10, the location of the UE is inferred from the Reference Signal Received Power (RSRP) of the serving beam, as reported by the UE, based on Channel State Information. If the UE is closer to the radio unit, then the serving beam RSRP will be stronger, in comparison to when the UE is further away.

Typically, the UE may measure the RSRP of the serving beam when the P2 procedure is performed, and send a report, and may thereafter send a report every 40 ms. If a discontinuous reception procedure is being used, then the UE may measure the RSRP of the serving beam and send a report to the network node every 80 ms.

However, although FIG. 11 shows an example where the RSRP of the serving beam is used as the measure of location of the mobile wireless device relative to the radio unit, such a measure can be obtained from any one of several different parameters, or from a combination of such parameters. For example, the measure of location of the mobile wireless device relative to the radio unit can be obtained from Timing Advance (TA) measurements based on signals transmitted between the mobile wireless device and the radio unit. As another alternative, if the mobile wireless device is provided with a Global Navigation Satellite System (GNSS) receiver, for example a Global Positioning System (GPS) receiver, it can determine its location directly, and report this to the network node, either continuously or when instructed to do so because it is close to a radio unit.

At step 142, it is determined whether the measure of the location indicates that the mobile wireless device is nearer to the radio unit than a speed-dependent threshold value.

In the example shown in FIG. 11, the measure of the location of the UE is a value for the Reference Signal Received Power (RSRP) of the serving beam, i.e. NB_{RSRP} in the case where the serving beam is a narrow beam, or WB_{RSRP} in the case where the serving beam is a wide beam.

Thus, suitable threshold values NB_{RSRP threshold} and WB_{RSRP threshold} can be set for these values.

The speed-dependent distance threshold could either be fixed for all mobile wireless devices (regardless of their speed) or could be more dynamic. For example, the speed of each mobile wireless device could be measured, and the speed-dependent threshold for a mobile wireless device could be set as the speed of the device changes.

Alternatively, a fixed speed-dependent threshold could be used in situations when typical movement speeds are known. For example, for a radio unit on a base station near a motorway, it could be assumed that vehicles are moving at up to or around 120 km per hour, and the speed-dependent threshold could be set to a suitable value for all mobile wireless devices based on that assumption. By contrast, a radio unit on a base station in an urban area could have a fixed speed-dependent threshold calculated on the assumption that mobile wireless devices are moving at speeds up to or around 50 km per hour.

Suitable values for the threshold values can be determined theoretically based on the relation between path loss and RSRP, or can be determined via data collected from lab and field tests, taking into consideration the required relationship between the time between measurement reports and the time taken by a mobile wireless device to cross a narrow beam at a particular distance from the radio unit.

Having set the speed-dependent threshold value, it can then be determined whether the measure of the location indicates that the mobile wireless device is nearer to the radio unit than the threshold value implies. That is, it can be determined whether

NB_{RSRP}≥NB_{RSRP threshold} (2)

in the case where the serving beam is a narrow beam, or

WB_{RSRP}≥WB_{RSRP threshold} (3)

in the case where the serving beam is a wide beam.

When the measure of the location indicates that the mobile wireless device is nearer to the radio unit than the speed-dependent threshold value, it may be switched to one of a plurality of predefined wide beams for data transfer between the radio unit and the mobile wireless device. Alternatively, when the measure of the distance indicates that the mobile wireless device is further from the radio unit than the speed-dependent threshold value, it may be switched to one of a plurality of predefined narrow beams for data transfer between the radio unit and the mobile wireless device.

Thus, if it is determined in step 142 that the measure of the distance indicates that the mobile wireless device is further from the radio unit than the speed-dependent threshold value, i.e., in the case where RSRP is used as the measure of the location, NB_{RSRP}<NB_{RSRP threshold} in the case where the serving beam is a narrow beam, or

WB_{RSRP}<WB_{RSRP threshold} in the case where the serving beam is a wide beam, the process passes to step 144. This means that the mobile wireless device is sufficiently far from the radio unit and travelling sufficiently slowly, that it is not in danger of losing its serving beam.

Then, if the serving beam is a narrow beam, the process passes to step 146, which specifies that the possible beam switches are switches to other narrow beams. For example, in the situation illustrated in FIG. 9, where the serving beam is the narrow beam NB1_1, the possible beam switches may be to other narrow beams such as NB2_1 and NB1_2. This is equivalent to the conventional situation, where all data transfer takes place using narrow beams.

If at step 144 the serving beam is a wide beam, the process passes to step 148, which specifies that the possible beam switches are switches to narrow beams. For example, in the situation illustrated in FIG. 9, where the serving beam is the wide beam WB1, the possible beam switches may be to other narrow beams such as NB1_1, NB1_2, and NB2_1.

Alternatively, if it is determined in step 142 that the measure of the distance indicates that the mobile wireless device is nearer to the radio unit than the speed-dependent threshold value, i.e., in the case where RSRP is used as the measure of the location, NB_{RSRP}≥NB_{RSRP threshold} in the case where the serving beam is a narrow beam, or

WB_{RSRP}≥WB_{RSRP threshold} in the case where the serving beam is a wide beam, the process passes to step 150. This means that the mobile wireless device is sufficiently near to the radio unit and travelling sufficiently fast, that it is in danger of losing its serving narrow beam.

Then, if the serving beam is a narrow beam, the process passes to step 152, which specifies that the possible beam switches are switches to wide beams. For example, in the situation illustrated in FIG. 9, where the serving beam is the narrow beam NB1_1, the possible beam switches may be to the wide beams WB1 and WB2.

If at step 150 the serving beam is a wide beam, the process passes to step 154, which specifies that the possible beam switches are switches to one or more other wide beam. For example, in the situation illustrated in FIG. 9, where the serving beam is the wide beam WB1, the possible beam switches may be to other wide beams such as WB2.

Whichever of steps 146, 148, 152, 154 is reached, the network node continues to monitor the CSI reports that it receives from the UE for the P2 procedure.

Thus, in these situations, if it is determined that a mobile wireless device is (or would be) in danger of losing a serving narrow beam, a wide beam is used for data transfer.

Thus, the algorithm enables dynamic data transfer on both narrow beams and wide beams, depending on the situation of a UE. This algorithm takes into consideration both the speed (either the actually measured speed, or an assumed speed depending on the deployment of the relevant radio unit) and the location of the UE with respect to the radio unit. When a user is further away from the radio unit, then the gNB switches to narrow beams for data transfer, and when the UE gets closer to the RU while moving at high speed, then the gNB switches to wide beams for data transfer thus avoiding frequent beam failures.

The possible beam switches, for data transfer in the beam tracking process, can be summarised in the following table:

| Item | Existing solution | Solution disclosed here |
|---|---|---|
| NB1_1 [symbol] NB1_2 | Allowed | Allowed |
| NB1_1 [symbol] WB1 or | Not allowed | Allowed |
| NB1_2 [symbol] WB2 | | |
| WB1 [symbol] WB2 | Not allowed | Allowed |

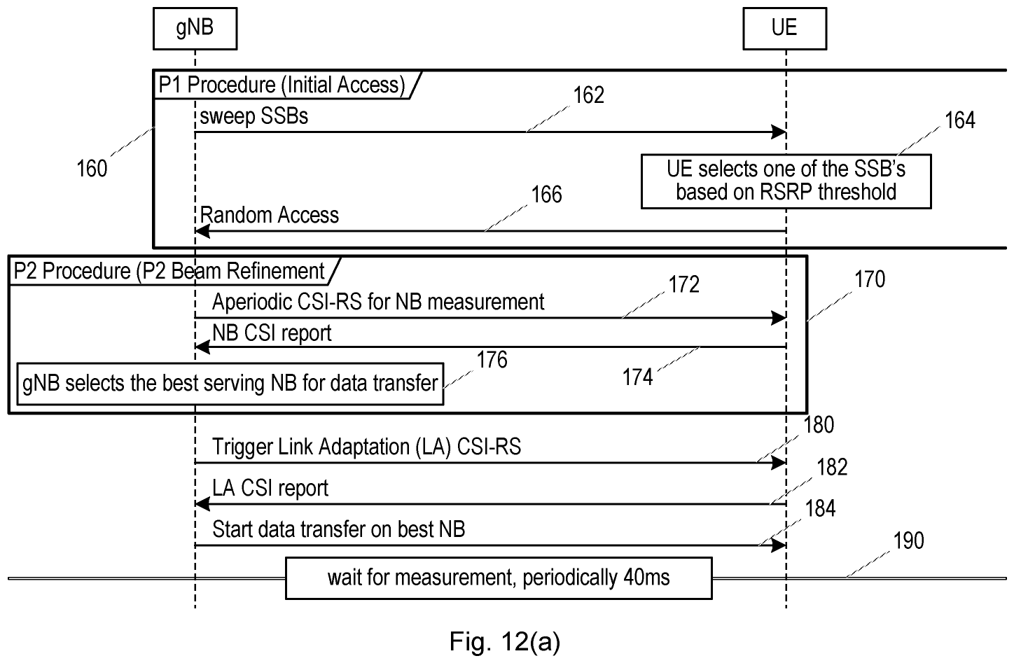

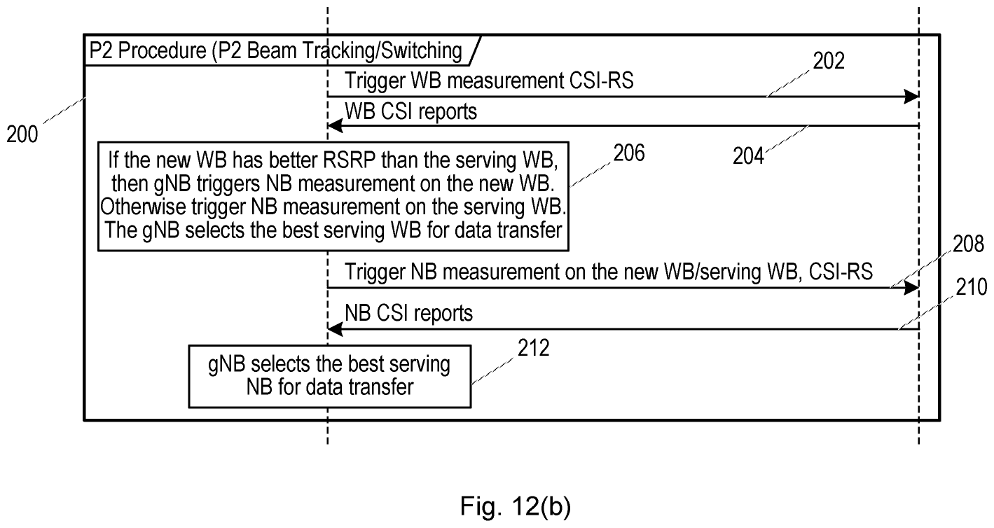

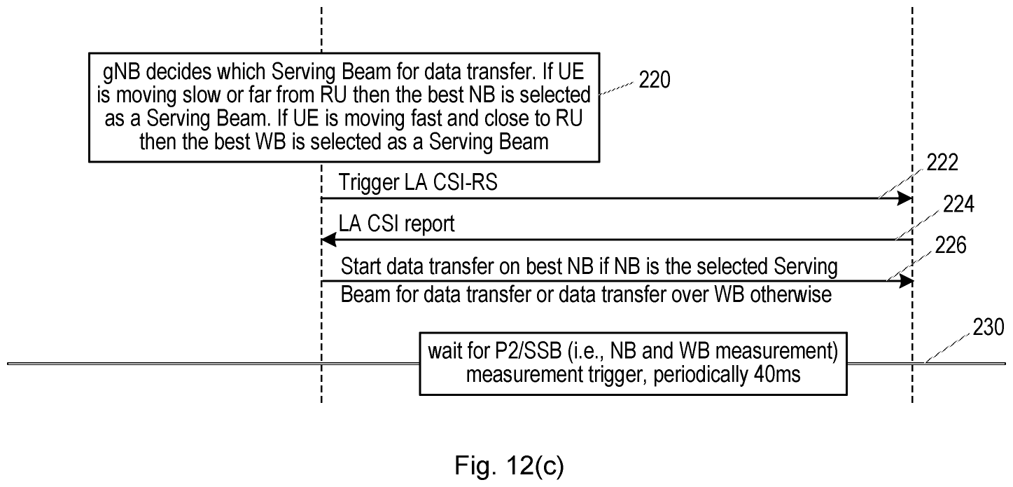

FIG. 12 is a third flow chart illustrating a method in accordance with an aspect of the invention, showing how the method of FIG. 11 is used to adapt the existing beam management solution between a gNB and a UE.

Box 160 shows the P1 procedure for beam establishment, in which at step 162 the gNB transmits the synchronization signal block (SSB) in a beam sweep over the coverage area. At step 164 the UE selects an SSB beam based on the measured Reference Signal Received Power values. As shown at step 166, the UE may then perform an initial access via the Physical Random Access Channel (PRACH).

Box 170 shows the P2 procedure for gNB beam refinement.

During the P2 procedure, at step 172, the gNB transmits the Aperiodic Channel State Information-Reference Signal (CSI-RS) in a beam sweep over the narrow beams within the wide beam that was selected in the P1 procedure. The UE monitors the received CSI, and at step 174 sends a report to the gNB. At step 176, based on these reports, the gNB is then able to find the best narrow beam within the previously selected wide beam, and it selects this narrow beam for the subsequent data transfer.

At step 180, the gNB transmits the Trigger Link Adaptation (LA) Channel State Information-Reference Signal (CSI-RS) to the UE, which sends an LA CSI report at step 182. Then, at step 184, the gNB is able to start data transfer on the selected narrow beam.

At step 190, the gNB and UE wait for the next measurement opportunity, the periodicity of which is signalled to the UE. For example, the periodicity may normally be 40 ms, but this can be extended to 80 ms if a form of discontinuous reception is used.

Box 200 shows the P2 procedure for beam tracking and switching.

During the P2 procedure, at step 202, the gNB sends a message to the UE, triggering it to make measurements on the wide beams, and at step 204 the UE sends the wide beam CSI reports.

At step 206, the gNB determines from the measurement reports whether there is a new wide beam that has a better RSRP than the serving wide beam. If so, then at step 208 the gNB triggers measurements on the narrow beams that make up that new wide beam. If not, then at step 208 the gNB triggers measurements on the narrow beams that make up the serving wide beam. In addition, the gNB determines which wide beam would be the best wide beam for data transfer.

At step 210, the UE sends the measurement reports relating to the measurements that it was instructed to make. At step 212, based on these measurement reports, the gNB determines which narrow beam would be the best narrow beam for data transfer. Up to this point, the method follows the conventional P1 and P2 procedures.

At step 220, the gNB performs the procedure set out in FIG. 11, in which it selects a beam for data transfer. If it determines that the UE is moving slowly enough or is far enough from the radio unit, it selects the best narrow beam as the beam for data transfer. By contrast if it determines that the UE is moving fast enough and is near enough to the radio unit, it selects the best wide beam as the beam for data transfer.

Thus, the P1 and P2 procedures identify the best available wide beam and the best available narrow beam. The process of FIG. 11 then determines whether the (measured or assumed, as discussed earlier) speed and the location of the UE are such that any beam switch should be to a narrow beam or to a wide beam.

At step 222, the gNB transmits the Trigger Link Adaptation (LA) Channel State Information-Reference Signal (CSI-RS) to the UE, which sends an LA CSI report at step 224. Then, at step 226, the gNB determines whether it is necessary to switch the data transfer from the serving beam. If so, the gNB is able to make the switch, and to start data transfer on the selected beam, which may be either a wide beam or a narrow beam, as determined by the process of FIG. 11.

During the data transfer, as shown at step 230, the UE makes the measurements required for the P2 procedure, and the process returns to step 190, in the same way that FIG. 11 shows the process returning from step 156 to step 140.

The method is therefore described with reference to a beam switching procedure, but the idea of using wide beams for data transfer can be extended to enable NR to NR mobility, namely via L2 beam switching using wide beams.

There is thus disclosed a system for flexible and dynamic data transfer via either narrow beams or wide beams, depending on the UE's (measured or assumed) speed and its location with respect to the radio unit, in order to provide improved beam tracking. This may result in reduced radio link failures due to beam losses, and reduced random access failures, without requiring changes to the 3GPP beam management procedures. Reducing beam losses and the number of random access attempts allows an increase in data transmission and throughput.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. A method of data transfer between a radio unit and a mobile wireless device, the method comprising:
obtaining a value for a measure of a location of the mobile wireless device relative to the radio unit; and
when the measure of the location indicates that the mobile wireless device is nearer to the radio unit than a speed-dependent threshold value, switching to one of a plurality of predefined wide beams for data transfer between the radio unit and the mobile wireless device; or
when the measure of the location indicates that the mobile wireless device is further from the radio unit than the speed-dependent threshold value, switching to one of a plurality of predefined narrow beams for data transfer between the radio unit and the mobile wireless device.

2. The method according to claim 1, comprising:
determining a value of a parameter that is dependent on the distance between the radio unit and the mobile wireless device;
comparing the determined value of the parameter with the speed-dependent threshold value; and
determining whether the mobile wireless device is relatively near to the radio unit, or relatively far from the radio unit, depending on whether the determined value of the parameter is greater than or less than the threshold value.

3. The method according to claim 2, wherein the parameter that is dependent on the distance between the radio unit and the mobile wireless device comprises a parameter relating to a signal strength of signals received by the radio unit from the mobile wireless device, comprising:
determining that the mobile wireless device is relatively near to the radio unit if the determined value of the parameter relating to the signal strength is greater than the speed-dependent threshold value, and determining that the mobile wireless device is relatively far from the radio unit if the determined value of the parameter relating to the signal strength is less than the speed-dependent threshold value.

4. The method according to claim 2, wherein the parameter that is dependent on the distance between the radio unit and the mobile wireless device comprises a parameter relating to a time taken for signals transmitted by the mobile wireless device to be received by the radio unit, comprising:
determining that the mobile wireless device is relatively near to the radio unit if the determined value of the parameter relating to the time taken is less than the speed-dependent threshold value, and determining that the mobile wireless device is relatively far from the radio unit if the determined value of the parameter relating to the time taken is greater than the speed-dependent threshold value.

5. The method according to claim 2, comprising:
determining a position of the mobile wireless device using a positioning system, wherein the parameter that is dependent on the distance between the radio unit and the mobile wireless device comprises a measure of said distance;
determining that the mobile wireless device is relatively near to the radio unit if the measure of said distance is less than the speed-dependent threshold value, and determining that the mobile wireless device is relatively far from the radio unit if the measure of said distance is greater than the threshold value.

6. The method according to claim 1, comprising setting the speed-dependent threshold value based on a measured or calculated speed of the mobile wireless device.

7. The method according to claim 1, comprising setting the speed-dependent threshold value based on an assumed speed of the mobile wireless device, dependent on a location of the radio unit.

8. The method according to claim 1, comprising: identifying a best available wide beam and a best available narrow beam;
based on the measure of the location and the speed-dependent threshold value, determining whether any switch should be to the best available wide beam or the best available narrow beam; and
if it is determined that a beam switch is necessary, switching to the best available wide beam or the best available narrow beam for data transfer between the radio unit and the mobile wireless device.

9. The method according to claim 8, comprising:
identifying the best available wide beam and the best available narrow beam based on measurement reports from the mobile wireless device.

10. The method according to claim 8, comprising:
determining whether a beam switch is necessary based on measurement reports from the mobile wireless device.

11. A system for data transfer between a radio unit and a mobile wireless device, the system being configured for:
obtaining a value for a measure of a location of the mobile wireless device relative to the radio unit; and
when the measure of the location indicates that the mobile wireless device is nearer to the radio unit than a speed-dependent threshold value, switching to one of a plurality of predefined wide beams for data transfer between the radio unit and the mobile wireless device; or
when the measure of the location indicates that the mobile wireless device is further from the radio unit than the speed-dependent threshold value, switching to one of a plurality of predefined narrow beams for data transfer between the radio unit and the mobile wireless device.

12. A network node comprising a processor and a memory, the memory containing instructions for causing the processor to perform a method comprising:
obtaining a value for a measure of a location of the mobile wireless device relative to the radio unit; and
when the measure of the location indicates that the mobile wireless device is nearer to the radio unit than a speed-dependent threshold value, switching to one of a plurality of predefined wide beams for data transfer between the radio unit and the mobile wireless device; or
when the measure of the location indicates that the mobile wireless device is further from the radio unit than the speed-dependent threshold value, switching to one of a plurality of predefined narrow beams for data transfer between the radio unit and the mobile wireless device.

13. A computer program product, comprising machine-readable instructions for causing a suitable programmed processor to perform a method comprising:
obtaining a value for a measure of a location of the mobile wireless device relative to the radio unit; and
when the measure of the location indicates that the mobile wireless device is nearer to the radio unit than a speed-dependent threshold value, switching to one of a plurality of predefined wide beams for data transfer between the radio unit and the mobile wireless device; or
when the measure of the location indicates that the mobile wireless device is further from the radio unit than the speed-dependent threshold value, switching to one of a plurality of predefined narrow beams for data transfer between the radio unit and the mobile wireless device.

14. A computer program product according to claim 13, wherein the instructions are stored on a tangible and/or non-transitory medium.
